(19) United States
(12) Patent Application Publication
(10) Pub. No.: US 2008/0036695 A1
(43) Pub. Date: Feb. 14, 2008

(54) Image display device, image display method and computer readable medium

(75) Inventors: Shinya Murai, Kawasaki-Shi (JP); Masataka Goto, Yokohama-Shi (JP); Kensaku Yamaguchi, Yokohama-Shi (JP); Yasuyuki Nishibayashi, Kawasaki-Shi (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/878,522

(22) Filed: Jul. 25, 2007

(30) Foreign Application Priority Data
Aug. 9, 2006 (JP) 2006-217373

(51) Int. Cl. G09G 5/12

(52) U.S. Cl. 345/2.3

(57) ABSTRACT

There is provided with a method of receiving application screen image from an information processing terminal through a wireless network and displaying the application screen image, and receiving moving picture image from a server apparatus through the network and displaying the moving picture image, including: carrying out processing of discarding frames from received moving picture image; synthesizing each frame of the moving picture image after frame discarding with received application screen image to generate synthesized image data for each frame of the moving picture image after the frame discarding; displaying a synthesized image using generated synthesized image data; accepting an input of control information which instructs control for the synthesized image displayed; transmitting accepted control information to the information processing terminal; and detecting that the control information has been accepted and carrying out processing of discarding frames from the received moving picture image.

### CROSS-REFERENCE TO RELATED APPLICATIONS

This application is based upon and claims the benefit of priority from the prior Japanese Patent Applications No. 2006-217373 filed on Aug. 9, 2006, the entire contents of which are incorporated herein by reference.

### BACKGROUND OF THE INVENTION

1. Field of the Invention

The present invention relates to an image display device, an image display method and a computer readable medium, and more particularly, to an image display device and an image display method for displaying image data received through a wireless network, and a computer readable medium storing a program for displaying image data received through a wireless network.

2. Related Art

In recent years, techniques for separating an information processing terminal such as a personal computer (hereinafter, referred to as a “PC”) from a display, sending/receiving application screen data to/from the display and the information processing terminal through a wireless network and thereby displaying an application screen on the display are disclosed (e.g., see JP-A 2002-304283 (Kokai) (page 4, FIG. 1)). In such a system in which an information processing terminal and a display are separated from each other, using, for example, a touch panel as the display allows the information processing terminal to be operated through pen-based input or the like.

To receive and display video data such as a moving picture from a server apparatus on a network in such a system in which an information processing terminal and a display are separated from each other, it is necessary to synthesize application screen data transmitted from the information processing terminal to the display and video data transmitted from the server apparatus to generate and display synthesized image data. At this time, the greater the number of image frames making up the moving picture data, the greater the processing load on the display to generate synthesized image data becomes.

Therefore, operating the information processing terminal through pen-based input or the like while reproducing the moving picture data results in a problem that the processing for transmitting inputted operation data or the like is delayed and a response to an operation on the information processing terminal is delayed.

### SUMMARY OF THE INVENTION

According to an aspect of the present invention, there is provided with an image display device for receiving application screen image from an information processing terminal which generates application screen image through a wireless network and displaying the application screen image, and receiving moving picture image from a server apparatus which stores the moving picture image including a plurality of frames through the wireless network and displaying the moving picture image, comprising:

a discarding unit configured to carry out processing of discarding frames from received moving picture image;

a synthesis unit configured to synthesize each frame of the moving picture image after frame discarding by the discarding unit with received application screen image to generate synthesized image data for each frame of the moving picture image after the frame discarding;

a display unit configured to display a synthesized image using generated synthesized image data;

an input accepting unit configured to accept an input of control information which instructs control for the synthesized image displayed on the display unit;

a transmission unit configured to transmit the control information accepted by the input accepting unit to the information processing terminal; and

an instruction unit configured to detect that the control information has been accepted by the input accepted unit and instruct the discarding unit to execute discarding processing.

According to an aspect of the present invention, there is provided with an image display method of receiving application screen image from an information processing terminal which generates application screen image through a wireless network and displaying the application screen image, and receiving moving picture image from a server apparatus which stores the moving picture image including a plurality of frames through the wireless network and displaying the moving picture image, comprising:

carrying out processing of discarding frames from received moving picture image;

synthesizing each frame of the moving picture image after frame discarding with received application screen image to generate synthesized image data for each frame of the moving picture image after the frame discarding;

displaying a synthesized image using generated synthesized image data;

accepting an input of control information which instructs control for the synthesized image displayed;

transmitting accepted control information to the information processing terminal; and

detecting that the control information has been accepted and carrying out processing of discarding frames from the received moving picture image.

According to an aspect of the present invention, there is provided with a computer readable medium storing a computer program for causing a computer receiving application screen image from an information processing terminal which generates application screen image through a wireless network and displaying the application screen image, receiving moving picture image from a server apparatus which stores the moving picture image including a plurality of frames through the wireless network and displaying the moving picture image, to execute instructions to perform steps of:

carrying out processing of discarding frames from received moving picture image;

synthesizing each frame of the moving picture image after frame discarding with received application screen image to generate synthesized image data for each frame of the moving picture image after the frame discarding;

displaying a synthesized image using generated synthesized image data;

accepting an input of control information which instructs control for the synthesized image displayed;

transmitting accepted control information to the information processing terminal; and

detecting that the control information has been accepted and carrying out processing of discarding frames from the received moving picture image.

### BRIEF DESCRIPTION OF THE DRAWINGS

FIG. 1 is a block diagram showing the configuration of an image display device according to an embodiment of the present invention;

FIG. 2 is a configuration diagram of a network system including the image display device according to the embodiment of the present invention;

FIG. 3 is a flow chart showing the operation of frame discarding processing by the image display device according to the embodiment of the present invention;

FIG. 4 shows an example of synthesized image data according to the embodiment of the present invention;

FIG. 5 is a flow chart showing the operation by the discarding processing instruction unit of the image display device according to the embodiment of the present invention;

FIG. 6 is a flow chart showing the operation by the discarding processing instruction unit of the image display device according to the embodiment of the present invention; and

FIG. 7 shows an example of a table showing control information associated with the type of a frame to be discarded according to the embodiment of the present invention.

### DETAILED DESCRIPTION OF THE INVENTION

Hereinafter, an embodiment of the present invention will be explained.

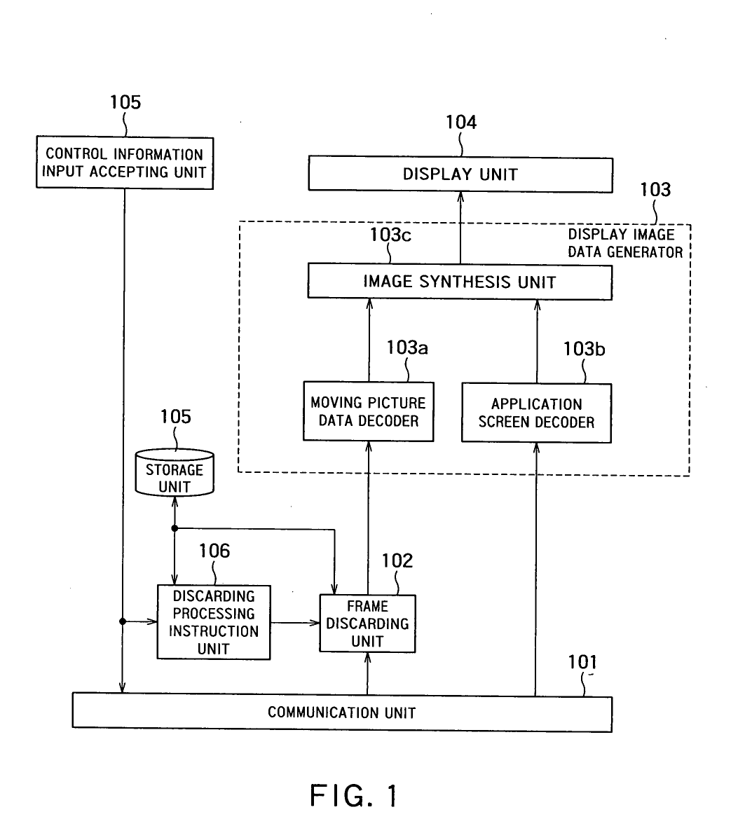

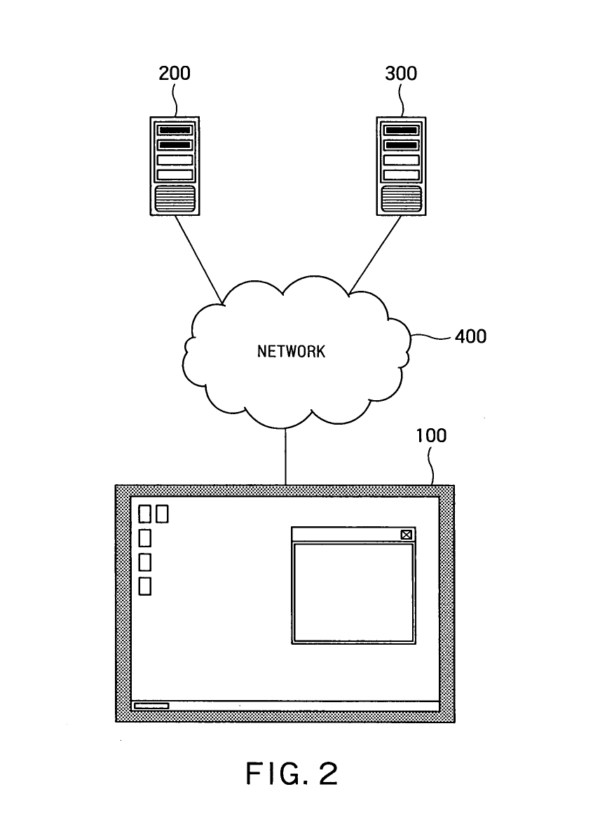

FIG. 1 is a block diagram showing the configuration of an image display device according to an embodiment of the present invention. Furthermore, FIG. 2 is a block diagram showing the configuration of a network system including the image display device according to the embodiment of the present invention.

As shown in FIG. 2, an image display device 100 according to the embodiment of the present invention is connected to an information processing terminal 200 such as a PC and a video content server apparatus 300 which stores and delivers moving picture data through a wireless network 400.

The video content server apparatus 300 is a server apparatus which can deliver video content data such as moving picture data to other communication terminals through the network. As the video content server apparatus 300, for example, a DMS (Digital Media Server) based on DLNA (Digital Living Network Alliance) which is a specification for interfacing between digital AV apparatuses and a personal computer on a home network can be used.

Here, suppose the moving picture data transmitted from the video content server apparatus 300 is composed of a plurality of image frames and compressed using, for example, a video data compression scheme such as MPEG.

The information processing terminal 200 transmits application screen data to be displayed to a client apparatus (here, image display device 100) connected through the network and causes the application screen data to be displayed. Furthermore, the information processing terminal 200 receives control information (e.g., operation information inputted from a user to the display image displayed on the image display device 100 such as start-up and exiting of a window, text input, movement of a mouse pointer) which is transmitted from the client apparatus (image display device 100) through the network and performs processing according to the control information received.

Here, the “application screen data” refers to screen data to provide for the user a result obtained by causing the information processing terminal to operate software designed for specific purposes such as creation of a document and numerical calculation. In recent years, graphics-intensive GUI (Graphical User Interface) is often used to display information to a user and the GUI also allows the user to input control information using a pointing device or the like through the screen thereof. Furthermore, a basic program to use the GUI is provided by the OS (Operating System) and using this allows the user to obtain standardized operability on application screens regardless of application software.

As the information processing terminal 200, it is possible to use, for example, one having a server function based on VNC (Virtual Network Computing), which is software to remotely control screens of other communication terminals connected through the network. Alternatively, between a server apparatus (information processing terminal 200) and a client apparatus (image display device 100), it is also possible to use one having a server function of RDP (Remote Desktop Protocol), which is a protocol used to transmit user input to the client apparatus (image display device 100) to the server apparatus (information processing terminal 200) and transmit screen information to be displayed from the server apparatus (information processing terminal 200) to the client apparatus (image display device 100).

Next, the configuration of each unit of the image display device 100 according to the embodiment of the present invention shown in FIG. 1 will be explained.

The image display device 100 according to this embodiment is provided with a communication unit 101 to perform data communication such as application screen data and moving picture data between the information processing terminal 200 and the video content data server apparatus 300 through the wireless network 400, a frame discarding unit 102 which discards image frames making up the moving picture data received at the communication unit 101 from the moving picture data, a display image data generator 103 which generates synthesized image data to be displayed using the moving picture data whose image frames have been discarded at the frame discarding unit, a display unit 104 which displays the synthesized image data to be displayed generated at the display image data generator 103, a control information input accepting unit 105 which accept an input of control information on the displayed image displayed on the display unit 104 and a discarding processing instruction unit 106 which detects that the control information has been accepted by the control information input accepting unit 105 and instructs the frame discarding unit 102 to execute discarding processing. The image display device 100 is also provided with a storage unit 107 which is a storage unit such as a memory or a hard disk. The storage unit 107 stores types or the like of frames to be discarded at the frame discarding unit 102.

Furthermore, the display image data generator 103 is provided with a moving picture data decoder 103a which decodes moving picture data whose frames have been discarded at the frame discarding unit 102, an application screen decoder 103b which decodes the application screen data received at the communication unit 101 and an image synthesis unit 103c which generates synthesized image data to be displayed by synthesizing the moving picture data decoded at the moving picture data decoder 103a and the application screen data decoded at the application screen decoder 103b. Here, the image synthesis unit 103c generates synthesized image data for each frame included in the moving picture data. The synthesized image data generated from each frame is sent to the display unit 104 on a time-series basis and displayed on the display unit 104.

The user of the image display device 100 can view the moving picture data together with the application screen through the synthesized image displayed on the display unit 104.

In the case that the user inputs control information on the displayed image such as start-up or exiting of a window, text input and movement of a mouse pointer while viewing the synthesized image displayed on the display unit 104, the user performs an input operation on the control information input accepting unit 105. As the control information input accepting unit 105, for example, a keyboard, mouse, touch panel (pen-based input) or the like can be used.

For example, when exiting a certain window displayed on the display unit 104 using a touch panel which allows pen-based input as the control information input accepting unit 105, the user performs an operation of clicking on an icon to close the window using a pen. Upon receiving the input from the user, the control information input accepting unit 105 generates control information data including information on the window to be operated and information on the operation to exit the window. The control information input accepting unit 105 then transmits the generated control information data to the information processing terminal 200 through the communication unit 101.

The information processing terminal 200 receives the control information data from the image display device 100, generates new application screen data and transmits the application screen data generated to the image display device 100.

In this way, it is possible to perform operation on the information processing terminal 200 from the image display device 100 through the wireless network 400.

Here, when the user inputs control information on the displayed image such as start-up or exiting of a window, text input and movement of the mouse pointer while viewing the synthesized image displayed on the display unit 104, the user's attention is assumed to be focused on the window, text or mouse pointer to be operated. Therefore, when there is input of control information to the control information input accepting unit 105 from the user, it may be preferable to discard a number of frames of the moving picture data displayed on the display unit 104 or the like so as to reduce the processing load of synthesizing the moving picture data with the application screen data and assign a throughput to the processing of transmitting the control information inputted from the user or the like because in this way it is assumed that response to the operation can be improved and a comfortable operation environment can be realized.

Therefore, the operation of the image display device according to the embodiment of the present invention which performs processing of discarding frames from the moving picture data at the frame processing unit 102 to reduce the processing load on the display image data generator 103 will be explained using FIG. 1 below.

First, the communication unit 101 receives application screen data transmitted from the information processing terminal 200. The application screen data received at the communication unit 101 is then sent to the application screen decoder 103b.

The application screen decoder 103b decodes the application screen data received at the communication unit 101.

Around the same time as this, moving picture data transmitted from the video content server apparatus 300 is received at the communication unit 101. The received moving picture data is sent to the frame discarding unit 102.

The frame discarding unit 102 has a first mode to perform processing of discarding frames from the moving picture data sent from the communication unit 101 and a second mode to send image frames of the moving picture data as they are to the moving picture data decoder 103a without performing frame discarding processing. Switching between the modes (that is, switching between the start and the end of frame discarding processing) is performed according to an instruction from the discarding processing instruction unit 106.

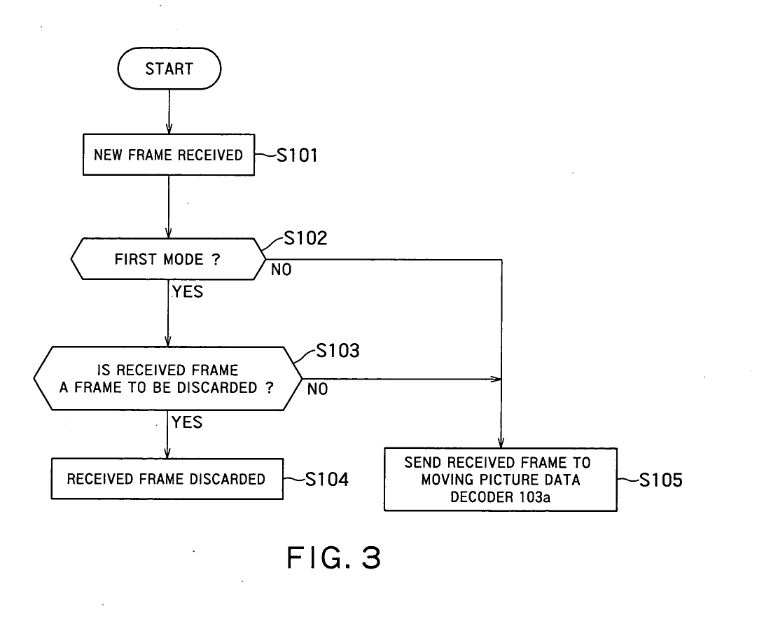

Hereinafter, the operation of the frame discarding processing at the frame discarding unit 102 will be explained using FIG. 3.

First, the frame discarding unit 102 receives a new image frame of moving picture data through the communication unit 101 (step S101).

Upon receiving the new image frame, the frame discarding unit 102 judges the mode (step S102). When the frame discarding unit 102 is in the second mode (mode in which frames are not discarded), the frame discarding unit 102 does not perform frame discarding processing (that is, without discarding the received image frame) and sends the received image frame to the moving picture data decoder 103a (step S105).

On the other hand, when the frame discarding unit 102 is in the first mode (mode in which frames are discarded), the frame discarding unit 102 judges whether or not the received image frame is a frame to be discarded (step S103). Here, the judgment as to whether or not the received frame is a frame to be discarded is made by storing the type of the frame to be discarded in the first mode in the storage unit 107 beforehand and referring to the type of the frame. That is, when the received frame matches the type of the frame stored in the storage unit 107, the received image frame is discarded (step S104).

When, for example, the moving picture data received has been compressed using an MPEG format compression scheme, of an I (Intra) frame and a P (Predicted) frame included in the moving picture data, only the P frame is stored as the frame to be deleted. Every time the communication unit 101 receives an image frame, the frame discarding unit 102 judges whether or not the received frame is an I frame or a P frame. The frame discarding unit 102 deletes the received frame when it is a P frame and send the received frame to the moving picture data decoder 103a when it is an I frame.

Alternatively, when, for example, the received moving picture data has been compressed using a Motion JPEG format compression scheme, the frame discarding unit 102 may be adapted so as to divide the received moving picture data every predetermined frames (e.g., 3 frames), send only the first frame out of the divided frames to the moving picture data decoder 103a and delete the remaining frames (e.g., 2 frames).

In this way, the frame discarding unit 102 can perform discarding processing of image frames included in the moving picture data.

The moving picture data after the frame discarding at the frame discarding unit 102 (image frames which have not been deleted) are then sent to the moving picture data decoder 103a.

The moving picture data decoder 103a decodes the moving picture data sent from the frame discarding unit 102. The moving picture data decoded at the moving picture data decoder 103a and the application screen data decoded at the application screen decoder 103b are then sent to the image synthesis unit 103c.

The image synthesis unit 103c synthesizes the decoded moving picture data and the application screen data and generates synthesized image data to be displayed.

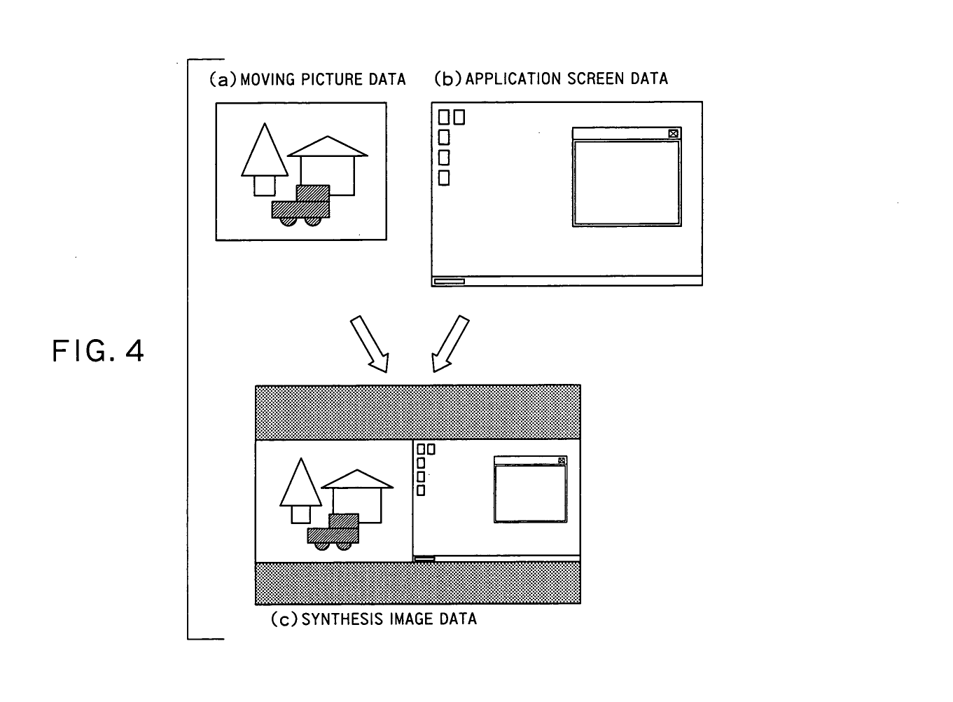

As shown in FIG. 4, the synthesized image data is generated for each image frame sent from the moving picture data decoder 103a by synthesizing the frame with the application screen data.

The synthesized image data generated is sent to the display unit 104 and displayed. As the display unit 104, a display device such as a liquid crystal display may be used.

In this way, the user can view a displayed image in which the moving picture data is synthesized through the display unit 104.

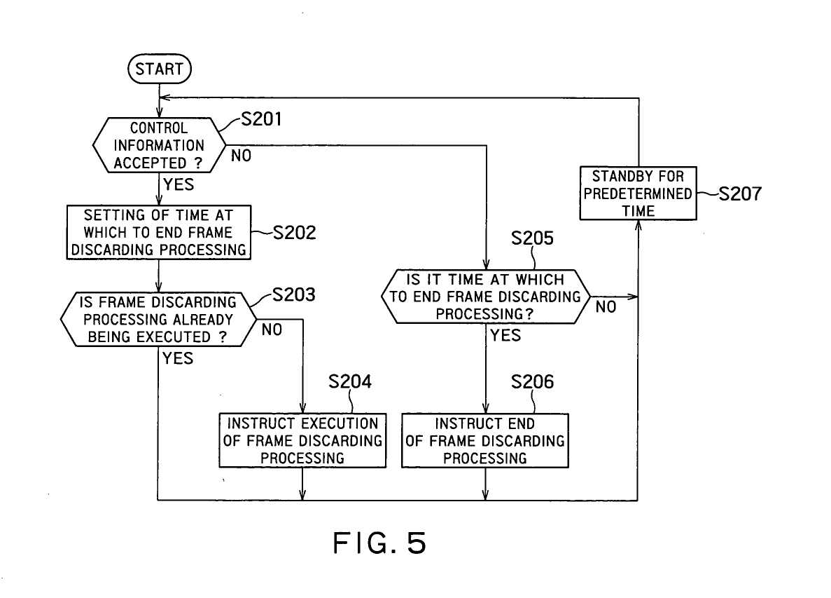

Next, when there is an input from the user to the control information input accepting unit 105 of the image display device 100, the operation of the discarding processing instruction unit 106 that instructs the frame discarding unit 102 to perform frame discarding processing will be explained using FIG. 5.

First, the control information input accepting unit 105 accepts the input of control information from the user. The control information input accepting unit 105 transmits the accepted control information to the information processing terminal 200 through the wireless network 400 from the communication unit 101.

The discarding processing instruction unit 106 is periodically detecting the presence/absence of input of control information to the control information input accepting unit 105 (step S201).

Upon detecting that control information has been accepted by the control information input accepting unit 105, the discarding processing instruction unit 106 then sets a time at which to end the frame discarding processing (step S202). Here, the time at which to end the frame discarding processing is a time at which the frame discarding processing should be ended when no control information has been accepted by the control information input accepting unit 105 for a predetermined time after starting the frame discarding processing. The time at which to end the frame discarding processing may be set, for example, by storing the time at which to end the frame discarding processing in the storage unit 107.

As for the time after starting the frame discarding processing until the frame discarding processing ends, an identical predetermined time may be used for all control information or a time which differs from one piece of control information to another may also be set.

For example, suppose a case where the control information is a command for “character input” to within a predetermined window on the display screen. In this case, the information processing terminal 200 which has received the control information through the communication unit 101 needs only to perform processing of displaying an inputted character string on the application screen. Therefore, the time after the control information is accepted by the control information input accepting unit 105 until the application screen data in which the processing result is reflected is displayed on the display unit 104 is assumed to be relatively short. Therefore, even if the time after the frame discarding processing is started until it is ended is set to a short time, it is considered hard to lead to a reduction of response for the screen display.

On the other hand, suppose a case where the control information is, for example, an “Enter” command which is inputted after link information is inputted on an Internet browser. In this case, the information processing terminal 200 which has received the control information through the communication unit 101 often needs to perform processing such as acquiring data stored at the link destination from the inputted link information and opening a new window which corresponds to the data. Therefore, the time after the control information is accepted by the control information input accepting unit 105 until the application screen data in which the processing result is reflected is displayed on the display unit 104 is assumed to be longer than the above described example of character input. Therefore, when the control information is an “Enter” command, it is desirable to set a longer time from the start to end of the frame discarding processing than in the aforementioned case of character input.

In this way, when the time during which the frame discarding processing is executed is changed for each piece of control information, the control information is stored in the storage unit 107 in association with the time during which the frame discarding processing is executed. The discarding processing instruction unit 106 is adapted so as to refer to the storage unit 107 and read the time during which the frame discarding processing is executed every time control information is accepted in step S201. The time at which to end the discarding processing in step S202 may be set based on the time during which discarding processing on the read frame is executed.

In this way, by changing the time during which the frame discarding processing is executed according to the control information accepted by the control information input accepting unit 105, it is possible to prevent the frame rate of the moving picture data whose frames have been discarded from unnecessarily decreasing.

After setting the time at which to end the frame discarding processing, the discarding processing instruction unit 106 then judges whether or not the frame discarding unit 102 has executed the frame discarding processing (step S203). In the case where the frame discarding unit 102 has already executed the frame discarding processing (first mode), the discarding processing instruction unit 106 does not give any instruction to the frame discarding unit 102 and waits for a predetermined time (step S207). On the other hand, when the frame discarding unit 102 has not executed the frame discarding processing (second mode), the discarding processing instruction unit 106 instructs the frame discarding unit 102 to start the frame discarding processing (step S204).

In this way, using the input of control information to the control information input accepting unit 105 as a trigger, the discarding processing instruction unit 106 can instruct the frame discarding unit 102 to execute the frame discarding processing. The frame discarding unit 102 can start the frame discarding processing of the moving picture data received at the communication unit 101 based on the instruction from the discarding processing instruction unit 106.

When no control information has been accepted by the control information input accepting unit 105 in step S201, the discarding processing instruction unit 106 judges whether or not it is the time at which the frame discarding processing should be ended (step S205). As described above, the discarding processing instruction unit 106 judges whether or not it is the time at which the frame discarding processing should be ended by referring to the time at which the frame discarding processing should be ended stored in the storage unit 107. When the time at which the frame discarding processing should be ended is not set, since the frame discarding unit 102 has not performed the frame discarding processing yet, the discarding processing instruction unit 106 does not give any instruction to the frame discarding unit 102 and waits for a predetermined time (step S207).

When the time at which to end the frame discarding processing is set, the discarding processing instruction unit 106 compares the current time with the time at which to end the frame discarding processing. When the time at which to end the frame discarding processing has already come, the discarding processing instruction unit 106 instructs the frame discarding unit 102 to end the frame discarding processing (step S206).

In this way, the discarding processing instruction unit 106 can instruct the frame discarding unit 102 to start and end the discarding processing on frames included in the moving picture data based on the input of the control information to the control information input accepting unit 105.

Here, the frame discarding processing by the frame discarding unit 102 is ended according to an instruction from the discarding processing instruction unit 106, but when the discarding processing instruction unit 106 instructs the frame discarding unit 102 to execute frame discarding processing, the discarding processing instruction unit 106 can also instruct the time during which the frame discarding processing is carried out so that the frame discarding unit 102 can end the frame discarding processing after carrying out the frame discarding processing for the specified time.

In this way, according to the image display device according to the embodiment of the present invention, when moving picture data is received through the network, and reproduced and displayed on the display unit 104, it is possible to discard frames included in moving picture data according to the input of control information from the user, reduce the processing load to reproduce moving picture data and improve the response to the input of control information from the user.

In the above described embodiment, when for example, there is an input of control information from the user such as start-up or exiting of a window to the control information input accepting unit 105, the discarding processing instruction unit 106 instructs the frame discarding unit 102 to execute the frame discarding processing on the moving picture data.

However, even if it is an input of control information from the user, an input instructing, for example, the movement of the pointer displayed on the screen may occur unintentionally by a wrong operation of the mouse or pen-based input or the like. In such a case, the user may often pay attention to the moving picture data being reproduced.

Therefore, the discarding processing instruction unit 106 stores control information which requires no instruction for the execution of discarding processing to be given to the frame discarding unit 102 in the storage unit 107. The discarding processing instruction unit 106 then compares the control information accepted at the control information input accepting unit 105 with the control information stored in the storage unit 107, and when the accepted control information does not require frame discarding processing to be executed, the discarding processing instruction unit 106 instructs the frame discarding unit 102 not to execute the discarding processing.

In the above described example, “movement of the pointer” is stored in the storage unit 107 as the control information not requiring frame discarding processing. When the control information accepted by the control information input accepting unit 105 is “movement of the pointer”, the discarding processing instruction unit 106 refers to the storage unit 107 and does not instruct the frame discarding unit 102 to execute frame discarding processing. On the other hand, when the control information accepted by the control information input accepting unit 105 is other than “movement of the pointer”, the discarding processing instruction unit 106 instructs the frame discarding unit 102 to execute discarding processing.

In this way, it is possible to cause the frame discarding unit 102 to execute discarding processing only when specific control information is accepted by the control information input accepting unit 105.

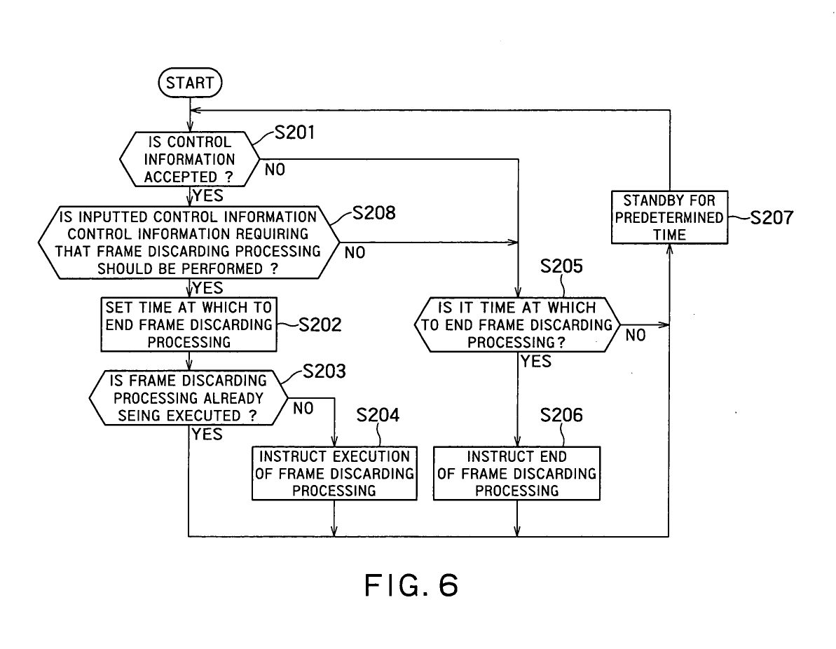

More specifically, as shown in the flow chart in FIG. 6, a step of judging whether or not the control information accepted by the control information input accepting unit 105 is control information requiring that frame discarding processing should be executed (step S208) is provided before step S202 of setting the time at which to end the frame discarding processing. When the control information accepted by the control information input accepting unit 105 is not control information requiring that frame discarding processing should be executed, it is possible to move to step S205 and prevent frame discarding processing from being executed according to the accepted control information.

In the above described example, the storage unit 107 stores control information according to which discarding processing need not be executed and the frame discarding unit 102 is instructed to execute discarding processing when control information other than the control information stored in the storage unit 107 is accepted. On the contrary, it is also possible to store control information requiring execution of discarding processing in the storage unit 107 and instruct the frame discarding unit 102 to execute discarding processing only when the stored control information is accepted.

Furthermore, the above described embodiment has been explained assuming that image frames of the moving picture data discarded by the frame discarding unit 102 are the same frame regardless of the control information accepted by the control information input accepting unit 105. On the other hand, it is also possible to change the type of image frames which are discarded by the frame discarding unit 102 according to the control information which is accepted by the control information input accepting unit 105.

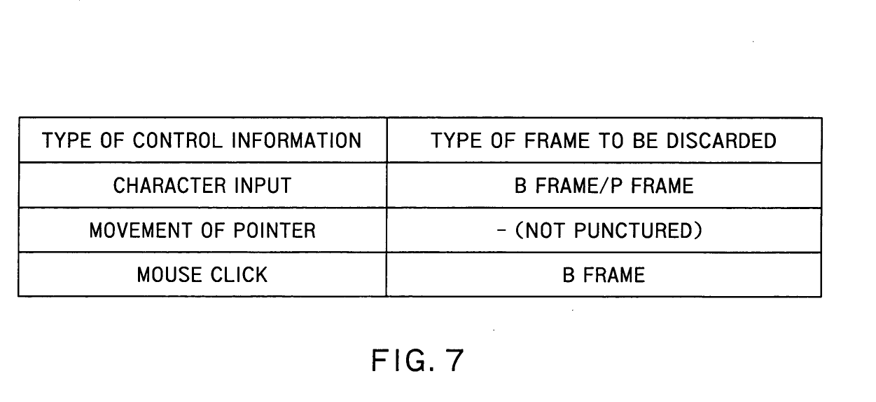

In this case, the storage unit 107 stores beforehand a table as shown in FIG. 7 in which the type of control information is associated with the type of a frame to be discarded when the control information is accepted. When instructing the frame discarding unit 102 to execute frame discarding processing, the discarding processing instruction unit 106 refers to the above described table and also instructs the type of frames to be discarded by the frame discarding unit 102 together. The frame discarding unit 102 discards frames of a predetermined type based on the instruction transmitted from the discarding processing instruction unit 106.

In the example in FIG. 7, when moving picture data is compressed using an MPEG format compression scheme, the table stores the type of frames such as I (Intra) frame, P (Predicted) frame and B (Bidirectional) frame as frames to be discarded associated with each piece of control information. When, for example, the control information accepted by the control information input accepting unit 105 is a command for carrying out “character input”, the discarding processing instruction unit 106 refers to the table shown in FIG. 7 and instructs the frame discarding unit 102 to discard the B frame and P frame. Furthermore, when the control information accepted by the control information input accepting unit 105 is “mouse click”, the discarding processing instruction unit 106 instructs the frame discarding unit 102 to discard only the B frame.

In this way, it is possible to change the processing load necessary to reproduce moving picture data according to control information accepted. That is, when control information requiring quick response is accepted, it is possible to increase the number of frames to be discarded, reduce the processing load for reproducing moving picture data and assign the throughput to transmission of control information or the like.

This image display device can also be realized using a general-purpose computer apparatus as the basic hardware. That is, the frame discarding unit 102, display image data generator 103, discarding processing instruction unit 106 or the like can be realized by causing a processor mounted on a computer apparatus to execute the above described program. At this time, the image display device 100 may be realized by installing the above described program in the computer apparatus beforehand or storing the above described program in a storage medium such as a CD-ROM or distributing the above described program through a network and installing this program in the computer apparatus as appropriate.

What is claimed is:

1. An image display device for receiving application screen image from an information processing terminal which generates application screen image through a wireless network and displaying the application screen image, and receiving moving picture image from a server apparatus which stores the moving picture image including a plurality of frames through the wireless network and displaying the moving picture image, comprising:
a discarding unit configured to carry out processing of discarding frames from received moving picture image;
a synthesis unit configured to synthesize each frame of the moving picture image after frame discarding by the discarding unit with received application screen image to generate synthesized image data for each frame of the moving picture image after the frame discarding;
a display unit configured to display a synthesized image using generated synthesized image data;
an input accepting unit configured to accept an input of control information which instructs control for the synthesized image displayed on the display unit;
a transmission unit configured to transmit the control information accepted by the input accepting unit to the information processing terminal; and
an instruction unit configured to detect that the control information has been accepted by the input accepted unit and instruct the discarding unit to execute discarding processing.

2. The device according to claim 1, wherein when the control information accepted by the input accepting unit is control information instructing movement of a pointer included in the synthesis image, the instruction unit does not instruct the discarding unit to execute discarding processing.

3. The device according to claim 1, further comprising a storage unit configured to store control information to be accepted by the input accepting unit in association with a type of frames to be discarded by the discarding unit when the control information is accepted,
wherein the instruction unit refers to the storage unit and instructs the discarding unit to execute discarding processing so as to discard frames to be discarded according to the control information accepted by the input accepting unit.

4. The device according to claim 1, wherein the instruction unit instructs the discarding unit to end discarding processing when control information is not accepted by the input accepting unit for a predetermined time after instructing the discarding unit to execute the discarding processing.

5. The device according to claim 1, further comprising a storage unit configured to store control information to be accepted by the input accepting unit associated with a time during which the discarding unit should continue discarding processing when the control information is accepted,
wherein the instruction unit refers to the storage unit and instructs the discarding unit to execute discarding processing for the time during which discarding processing should be continued according to the control information accepted by the input accepting unit.

6. The device according to claim 1, wherein when a plurality of frames included in the received moving picture image are compressed using an MPEG format compression scheme, the discarding unit discards frames by deleting P (Predicted) frames out of the plurality of received frames.

7. An image display method of receiving application screen image from an information processing terminal which generates application screen image through a wireless network and displaying the application screen image, and receiving moving picture image from a server apparatus which stores the moving picture image including a plurality of frames through the wireless network and displaying the moving picture image, comprising:
carrying out processing of discarding frames from received moving picture image;
synthesizing each frame of the moving picture image after frame discarding with received application screen image to generate synthesized image data for each frame of the moving picture image after the frame discarding;
displaying a synthesized image using generated synthesized image data;
accepting an input of control information which instructs control for the synthesized image displayed;
transmitting accepted control information to the information processing terminal; and
detecting that the control information has been accepted and carrying out processing of discarding frames from the received moving picture image.

8. The method according to claim 7, wherein when accepted control information is control information instructing movement of a pointer included in the synthesis image, the processing of discarding frames is not carried out.

9. The method according to claim 7, further comprising providing a storage unit configured to store control information to be accepted in association with a type of frames to be discarded when the control information is accepted,
wherein the carrying out processing of discarding frames includes referring to the storage unit and carrying out discarding processing so as to discard frames to be discarded according to accepted control information.

10. The method according to claim 7, wherein the processing of discarding frames is ended when control information is not accepted for a predetermined time after starting the discarding processing.

11. The method according to claim 7, further comprising providing a storage unit configured to store control information to be accepted associated with a time during which discarding processing should be continued when the control information is accepted,
wherein the carrying out processing of discarding frames includes referring to the storage unit and carrying out discarding processing for the time during which the discarding processing should be continued according to accepted control information.

12. The method according to claim 7, wherein when a plurality of frames included in the received moving picture image are compressed using an MPEG format compression scheme, the processing of discarding frames is carried out by deleting P (Predicted) frames out of the plurality of received frames.

13. A computer readable medium storing a computer program for causing a computer receiving application screen image from an information processing terminal which generates application screen image through a wireless network and displaying the application screen image, receiving moving picture image from a server apparatus which stores the moving picture image including a plurality of frames through the wireless network and displaying the moving picture image, to execute instructions to perform steps of:
carrying out processing of discarding frames from received moving picture image;
synthesizing each frame of the moving picture image after frame discarding with received application screen image to generate synthesized image data for each frame of the moving picture image after the frame discarding;
displaying a synthesized image using generated synthesized image data;
accepting an input of control information which instructs control for the synthesized image displayed;
transmitting accepted control information to the information processing terminal; and
detecting that the control information has been accepted and carrying out processing of discarding frames from the received moving picture image.

14. The medium according to claim 13, wherein when accepted control information is control information instructing movement of a pointer included in the synthesis image, the processing of discarding frames is not carried out.

15. The medium according to claim 13, further for causing the computer to execute instructions to perform accessing a storage unit configured to store control information to be accepted in association with a type of frames to be discarded when the control information is accepted,
wherein the carrying out processing of discarding frames includes referring to the storage unit and carrying out discarding processing so as to discard frames to be discarded according to accepted control information.

16. The medium according to claim 13, wherein the processing of discarding frames is ended when control information is not accepted for a predetermined time after starting the discarding processing.

17. The medium according to claim 13, further for causing the computer to execute instructions to perform accessing a storage unit configured to store control information to be accepted associated with a time during which discarding processing should be continued when the control information is accepted,
wherein the carrying out processing of discarding frames includes referring to the storage unit and carrying out discarding processing for the time during which the discarding processing should be continued according to accepted control information.

18. The medium according to claim 13, wherein when a plurality of frames included in the received moving picture image are compressed using an MPEG format compression scheme, the processing of discarding frames is carried out by deleting P (Predicted) frames out of the plurality of received frames.
